(19) United States
(12) Patent Application Publication
(10) Pub. No.: US 2012/0192375 A1
(43) Pub. Date: Aug. 2, 2012

(54) DEVICE FOR SUPPLYING A CLEANING LIQUID FOR AN AUTOMOBILE

(75) Inventors: Franck Cathala, St. Martin Laguepie (FR); Denis Thebault, Vanves (FR)

(73) Assignee: Valeo Systémes d'Essuyage, La Verriére (FR)

(21) Appl. No.: 13/499,072

(22) PCT Filed: Sep. 24, 2010
(86) PCT No.: PCT/EP2010/064146

§ 371 Date: Apr. 17, 2012

(30) Foreign Application Priority Data
Oct. 7, 2009 (FR) 0904794

(51) Int. Cl. B60S 1/52; F16K 49/00

(52) U.S. Cl. 15/250.02; 137/334

(57) ABSTRACT

The invention relates to a device (1) for supplying a cleaning liquid for an automobile, characterized in that it includes a liquid distribution member (2) including at least one liquid inlet and at least two liquid outlets, a check valve capable of preventing a liquid flow from each liquid outlet towards each liquid inlet, wherein the device (1) for supplying a cleaning liquid further includes heating means (4) thermally coupled with the liquid distribution member (2).

The present invention relates to a device for routing a cleaning liquid for automobile vehicles, and notably windshield washer liquid. It also relates to the use of the device for supplying liquid to at least one sprayer for automobile vehicles.

The description hereinafter relates mainly, although not exclusively, to routing a liquid for cleaning a glazed surface of an automobile vehicle, such as the windshield, the rear window or the exterior parts of the headlights or headlamps.

Improved cleaning of glazed surfaces may be obtained by heating the cleaning liquid before it is sprayed onto the surface to be cleaned by means of one or more sprayers. By sprayer is meant a pressurized sprayer orifice disposed either on the hood of the automobile vehicle or a sprayer manifold integrated directly into a windshield wiper. Moreover, the heated cleaning liquid may also assist with operations to de-ice the windshield.

A washing liquid device, whether the liquid is heated or not, mainly comprises at the level of the grille of the vehicle a liquid distribution element intended for the quick connection of pipes situated under the hood with pipes leading to the sprayers of the vehicle.

It is desirable, in the event of low temperatures, to prevent the formation of ice in the device in order to assure the continuity of the circulation of cleaning liquid in the device. It is also desirable to store the liquid as close as possible to the wipers, in such a manner as to obtain a satisfactory response time of the hydraulic system.

The invention intends to achieve these objectives.

Thus the invention consists in a device for routing a cleaning liquid for automobile vehicles.

The device of the invention comprises a liquid distribution member including at least one liquid inlet and at least two liquid outlets, a check valve for preventing a flow of fluid from each fluid outlet toward each fluid inlet, the device for routing a cleaning liquid further including heating means thermally coupled to the liquid distribution member.

Thus, thanks to the conjugate action of the check valve and the heating means at the level of the fluid distribution member, circulation of the fluid between the pipes present under the hood and the pipes near the surfaces to be cleaned is maintained, as is good hydraulic action of the device.

The liquid distribution member may comprise at least one subassembly provided with a liquid inlet connected to a check valve and two liquid outlets. The liquid distribution member may for example comprise two subassemblies each provided with a liquid inlet and two liquid outlets.

The heating means may be disposed between the two subassemblies.

The liquid inlets of the two subassemblies are advantageously connected to a bidirectional pump.

The heating means may include at least one positive temperature coefficient stone.

The invention also consists in the use of the device described hereinabove to supply liquid to at least one sprayer for automobile vehicles.

It notably consists in the use of a device including a liquid distribution member comprising two subassemblies each provided with a liquid inlet connected to a check valve and two liquid outlets for supplying liquid to a system for wiping a glazed surface comprising two wipers, each wiper being equipped with a first sprayer to enable distribution of liquid from a first side of the wiper during an upward sweeping phase and a second sprayer enabling distribution of liquid on the other side of the wiper during a downward sweeping phase, the liquid outlets of one subassembly of the liquid distribution member being intended to supply liquid to the first sprayers of the wipers, the liquid outlets of the other subassembly being intended to supply liquid to the second sprayers of the wipers.

Other features and advantages of the present invention will become more clearly apparent on reading the following description, given by way of illustrative and nonlimiting example and with reference to the appended drawings, in which:

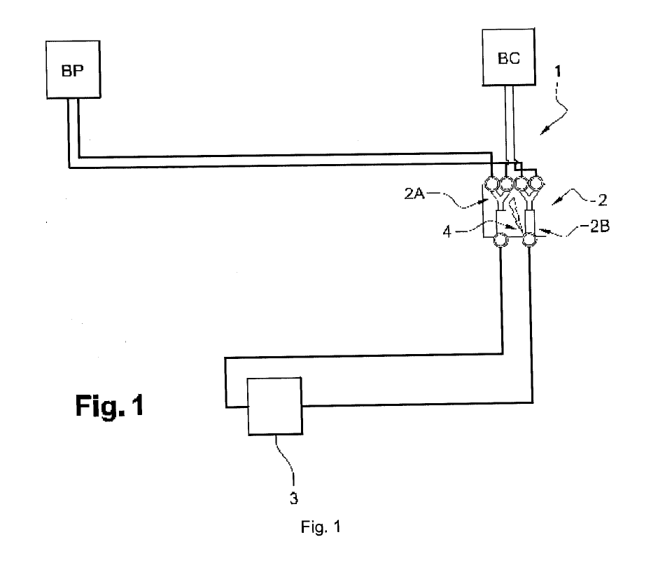

FIG. 1 shows diagrammatically a device of the invention for routing a cleaning liquid,

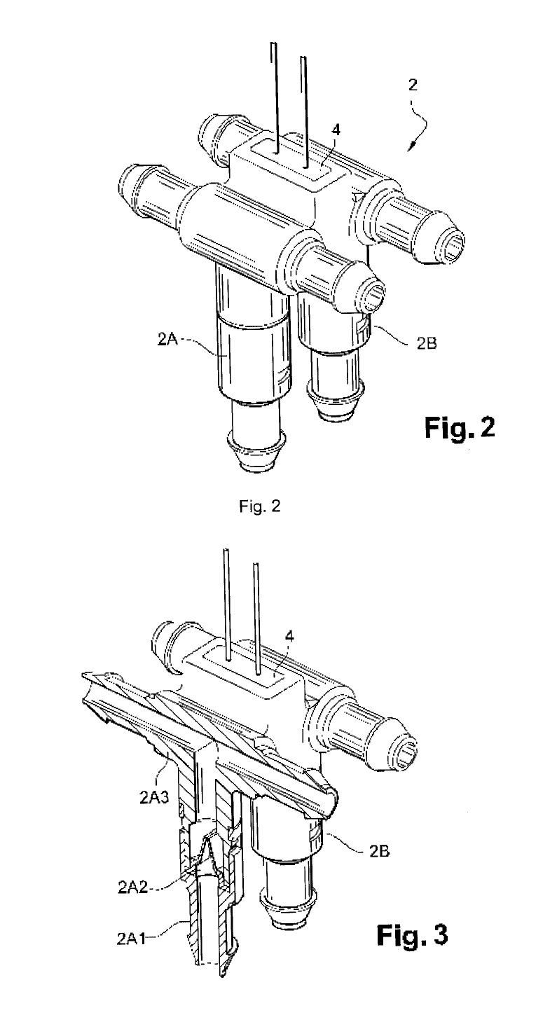

FIG. 2 is a general view of a liquid distribution member of the device, and

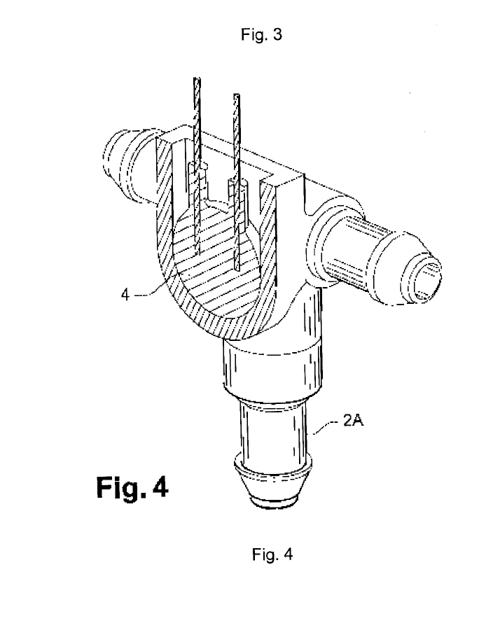

FIGS. 3 and 4 are partial views of the liquid distribution member.

The device 1 for routing cleaning liquid for automobile vehicles shown in FIG. 1 comprises a liquid distribution member 2. The liquid distribution member 2 is connected on the upstream side to a bidirectional pump 3 and on the downstream side to a passenger-side wiper BP situated on the passenger side and to a driver-side wiper BC situated on the driver side.

The wipers BP and BC are each provided with a first sprayer to enable distribution of liquid from a first side of the wiper during an upward sweeping phase and a second sprayer enabling distribution of liquid on the other side of the wiper during a downward sweeping phase. The fluid distribution member 2 is placed before the connection with the pipes under the arms BP and BC.

The liquid distribution member 2 comprises two subassemblies 2A, 2B between which is disposed a heating member 4.

The subassembly 2A comprises a liquid inlet fed with liquid by the pump 3 and two liquid outlets. One liquid outlet of the subassembly 2A is connected to the first sprayer of the wiper BP while the other liquid outlet of the subassembly 2A is connected to the first sprayer of the wiper BC.

Similarly, the subassembly 2B comprises a liquid inlet fed with liquid by the pump 3 and two liquid outlets. One liquid outlet of the subassembly 2B is connected to the second sprayer of the wiper BP while the other liquid outlet of the subassembly 2B is connected to the second sprayer of the wiper BC.

Accordingly, during the upward sweeping phase, the pump 3 feeds the first sprayers of the wipers BP and BC with liquid via the subassembly 2A. During the downward sweeping phase, the pump 3 supplies the second sprayers of the wipers BP and BC via the subassembly 2B.

Alternatively, instead of the pump 3 there may be used two monodirectional pumps each feeding a liquid inlet of the liquid distribution member 2.

FIGS. 2 to 4, in which identical elements carry the same references, are detail views of the liquid distribution member 2.

The liquid distribution member 2, as shown in FIG. 2, comprises the two subassemblies 2A and 2B. An opening is formed between the two subassemblies to accommodate the known heating member 4.

As shown in FIG. 3, the subassembly 2A comprises a lower portion 2A1 that is an area for quick fitting to a connector or for direct connection to a pipe. The subassembly 2A also comprises a middle area 2A2 which is an area accommodating a check valve, as well as an upper area 2A3 which is an area separating the inlet passage into two portions each leading to a fluid outlet. Each fluid outlet may comprise an area for quick fitting to a connector or for direct connection to a pipe. The check valve may be chosen from known check valves, and notably from guided valve member, flap, double flap, ball or concentric disk check valves. The envelope of the lower area 2A1 advantageously constitutes the cap of the check valve. For optimum action of the heating member 4, the latter will advantageously be thermally coupled to the area 2A3 separating the inlet passage into two parts. It is to be noted that the subassembly 2B has the same structure as the subassembly 2A.

Each subassembly 2A, 2B may comprise at least two liquid outlets, the number of outlets advantageously being equal to the number of wipers. Each subassembly 2A, 2B may moreover have a different shape, for example a T-shape or a V-shape.

FIG. 4 shows the intermediate area between the subassemblies 2A and 2B in which the heating member 4 is accommodated. The heating member 4 is advantageously a positive temperature coefficient stone. There could equally well be used as heating member a heating resistance, a resistive wire or any other heating element.

The use of positive temperature coefficient stones has a number of advantages. First of all, the heating temperature obtained by electrically powering this type of thermistor is self-limiting. To be more precise, these thermistors increase in temperature until a substantially constant temperature value is reached, corresponding to the so-called autoregulation temperature. It is therefore unnecessary to provide particular control devices for the regulation of these members.

Moreover, to raise the temperature of a flat positive temperature coefficient stone, it suffices to connect one of its faces electrically to a first DC voltage, the other face receiving a second DC voltage, typically ground.

1. A device for routing a cleaning liquid for an automobile vehicle, comprising:
a liquid distribution member comprising at least one liquid inlet and at least two liquid outlets;
a check valve for preventing a flow of fluid from each of the at least two liquid outlets toward each of the at least one liquid inlet: and
a heating element thermally coupled to the liquid distribution member.

2. The device as claimed in claim 1, wherein the liquid distribution member further comprises at least one subassembly provided with a liquid inlet connected to a check valve and two liquid outlets.

3. The device as claimed in claim 1, wherein the liquid distribution member further comprises two subassemblies, each provided with a liquid inlet and two liquid outlets.

4. The device as claimed in claim 3, wherein the heating means are disposed between the two subassemblies.

5. The device as claimed in claim 3, wherein the liquid inlets of the two subassemblies are connected to a bidirectional pump.

6. The device as claimed in claim 1, wherein the heating element comprises at least one positive temperature coefficient stone.

7. The device as claimed in claim 1, wherein the device is used to supply liquid to at least one sprayer for automobile vehicles.

8. The device as claimed in claim 3, wherein the device is for supplying liquid to a system for wiping a glazed surface comprising two wipers, each wiper being equipped with a first sprayer to enable distribution of liquid from a first side of each wiper during an upward sweeping phase and a second sprayer enabling distribution of liquid on a second side of each wiper during a downward sweeping phase, the liquid outlets of one subassembly of the liquid distribution member configured to supply liquid to the first sprayers of the two wipers, and the liquid outlets of the other subassembly configured to supply liquid to the second sprayers of the two wipers.
